(19) United States
(12) Patent Application Publication
(10) Pub. No.: US 2012/0170328 A1
(43) Pub. Date: Jul. 5, 2012

(54) Multimodal LED Power Supply With Wide Compliance Voltage and Safety Controlled Output

(75) Inventor: Denny D. Beasley, La Grange Park, IL (US)

(73) Assignee: ROBERTSON TRANSFORMER CO., Blue Island, IL (US)

(21) Appl. No.: 13/378,541

(22) PCT Filed: Jun. 18, 2010
(86) PCT No.: PCT/US10/39215

§ 371 Date: Mar. 1, 2012

Related U.S. Application Data
(60) Provisional application No. 61/218,789, filed on Jun. 19, 2009.

(51) Int. Cl. H02M 3/335

(52) U.S. Cl. 363/21.12

(57) ABSTRACT

A power supply for a non-linear load such as a light emitting diode load uses a voltage dynamic of a fly-back topology to correct for a rippling of an unfiltered rectified line voltage. Efficiency is optimized by utilizing a magnetic core bi-directionally. A transformer has two primaries 11,12 that are nearly identical. The connection of the primaries is phase add. The two primaries 11,12 are electrically connected in series but isolated by a capacitor C1 (14). This capacitor (14) both isolates and controls the rate of change of current with time and, therefore, the voltage on the secondary, SEC2 (16). For maximum efficiency, the capacitor (14) is select to provide the lowest rise of voltage across the switch during the instant just after being biased off.

### CROSS-REFERENCE TO RELATED APPLICATIONS

The present invention claims the benefit of U.S. Provisional Patent Application No. 61/218,789 filed Jun. 19, 2009, the contents of which are incorporated herein by reference.

### FEDERALLY SPONSORED RESEARCH OR DEVELOPMENT

N/A

### TECHNICAL FIELD

The invention relates to ballast controls for lighting.

### BACKGROUND OF THE INVENTION

Power supplies are identified by operational type e.g. single ended forward, flyback, push pull, etc. Also to make their performance on mains more acceptable, such as meet line harmonic standards, such as IEC 61000-2-3, a pre-converter is used to correct the harmonic conditions that result from simply rectifying the incoming mains voltage. This increases the cost and complexity of the power supply circuit, reduces overall efficiency and size. The use of LED's in many lighting applications require small size and high efficiency's to make their use practical as energy saving devices. This invention provides solutions for applications where simplicity can provide good mains performance and efficiency with a single power conversion step.

The present invention is provided to solve the problems discussed above and other problems, and to provide advantages and aspects not provided by prior controls of this type. A full discussion of the features and advantages of the present invention is deferred to the following detailed description, which proceeds with reference to the accompanying drawings.

### SUMMARY OF THE INVENTION

This invention utilizes a single power device to provide energy conversion as well as power factor correction in a single step. This method also provides the capacity to expand its output voltage dynamic range.

One aspect of the present invention is directed to a power supply with multimodal operation topology. The power supply comprises a fly-back forward operation having low distortion and a high power factor utilizing a one lone power component.

The first aspect of the invention may include one or more of the following features, alone or in any reasonable combination. The power supply may further comprise a means for providing expanded compliance voltage. The power supply may further comprise a split winding to operate in a multi-modal topology to optimize power throughput by using a magnetic core bi-directionally. The power supply may further comprise a means for detecting a zero cross-point and mitigating a control based on a load demand and a phase location of an input mains waves-shape. The means for detecting a zero cross-point and mitigating a control based on a load demand and a phase location of an input mains waves shape may provide an improvement of a line power factor and distortion by mitigating an instantaneous value along a driving voltage wave. The means for detecting a zero cross-point and mitigating a control based on a load demand and a phase location of an input mains waves shape may enhance the input mains waves shape such that the input mains waves shape substantially mimics a voltage wave shape. The power supply may further comprise a means for intentionally introducing distortion to create harmonics for negating an input mains distortion to improve mains efficiencies by reducing a transformer K factor.

Another aspect of the present invention is directed to a power supply for a non-linear load. The power supply comprises a fly-back circuit to correct for a rippling of a line voltage and a means for optimizing efficiency by utilizing a magnetic core of the fly-back circuit bi-directionally.

The second aspect of the invention may include one or more of the following features, alone or in any reasonable combination. The line voltage may be unfiltered. A flux in the magnetic core may go from a negative flux value to a positive flux value. The fly-back circuit may comprise a pair of primary coils electrically connected in series. A first primary coil in the pair of primary coils may be isolated from a second primary coil in the pair of primary coils by a capacitor. The fly-back circuit may comprise a secondary coil wherein a voltage on the secondary coil is controlled by the capacitor. The first primary coil and the second primary coil may be bifilar wound and oppositely phased. A power factor of the power supply may be maintained at levels of greater than 90% with total harmonic distortions of less than 20%. The power supply may further comprise a means for adjusting a pulse width from a zero cross point to a peak to equalize voltage across the secondary coil. The means for adjusting the pulse width may comprise a microcontroller. The power supply of may further comprise means for detecting a zero cross-point and mitigating a control based on a load demand and a phase location of an input mains waves-shape. The means for detecting a zero cross-point and mitigating a control based on a load demand and a phase location of an input mains waves shape may provide an improvement of a line power factor and distortion by mitigating an instantaneous value along a driving voltage sine wave. The means for detecting a zero cross-point and mitigating a control based on a load demand and a phase location of an input mains waves shape may enhance the input mains waves shape such that the input mains waves shape substantially mimics a voltage wave shape. The power supply may further comprise a means for intentionally introducing distortion to create harmonics for negating an input mains distortion to improve mains efficiencies by reducing a transformer K factor.

Another aspect of the invention is directed to a control apparatus comprising a means for using control algorithms to provide a controlled output for safe efficient control of an output state. This control apparatus may further comprise a means for sensing for an output conduction and terminating on a detection of a no load situation.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a circuit diagram of a description of single ended forward converter for reference;

FIG. 2 is a circuit diagram of a fly back controller of the invention;

FIG. 3 is a circuit diagram topology of the current invention;

FIG. 4 is a circuit diagram of a line input circuit of the invention;

FIG. 5 is a plot of wave shapes of the current invention;

FIG. 6 is a schematic drawing of a winding arrangement of the invention;

FIG. 7 is a basic flow chart of the operation of the invention;

FIG. 8 is a flowchart showing of added control flow low input current distortion of the invention; and

FIG. 9 is a schematic circuit diagram of the invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

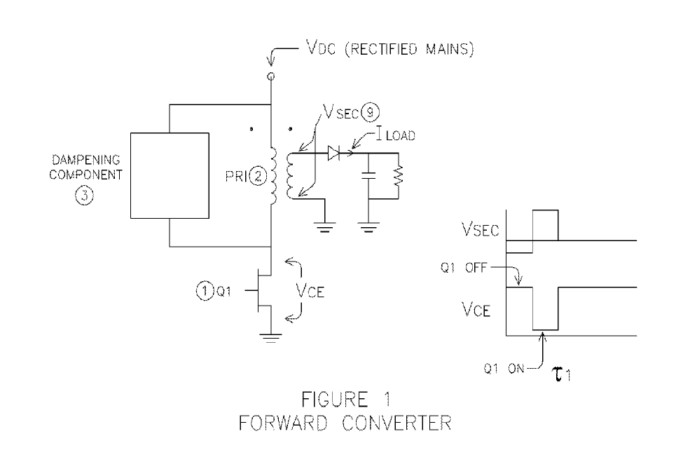

FIG. 1 shows a typical single ended forward converter. In this topology, Q1 (1) is the driven switching device, and its waves-shapes are also shown. When the switch Q1 (1) is off, the voltage across the primary (2) is nearly zero. When the switch is driven on, current flows from the energy source through the primary (2), and to a much lesser degree the dampening network (3). During this time, when the switch Q1 (1) is biased on, a flux in the core changes and is transformed in level in the secondary to a new desired level. Energy is extracted during this period when the driver is on thus the reference forward—meaning first action, field effect transistor (FET) Q1 (1) on. When the switch Q1 (1) is biased off, energy is released that was stored in the transformers magnetic field. This is dampened in the topology by a network that dissipates that energy while limiting the voltage rise to safe levels. This topology is limited to low power applications and does not utilize the magnetic to its fullest as the magnetic field is unidirectional in nature, and the energy stored in that field has to be dissipated on each cycle.

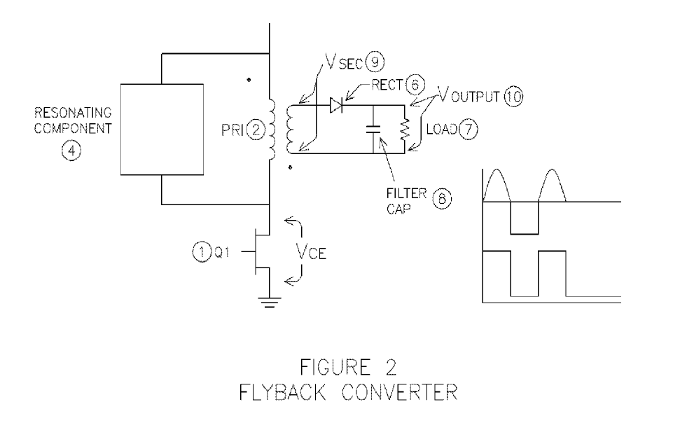

In FIG. 2, we see a topology that appears very similar except for the phasing of the secondary. When Q1 (1) is biased on, the secondary potential is such that the rectifier (6) is biased off, and no current flows into the filter cap (8) and load (7). When the switch Q1 (1) is biased off, the stored energy through a resonating component (4) controls the rate of fall of the stored energy and, therefore, the magnetic field in the primary (2) and core, and it generates a potential in the secondary (9) that forward biases the rectifier and thus feeds the transformed voltage source. This topology also suffers from low efficiency since only one of the two possible states of the switch device passes energy to output voltage source (10). But it does have one advantage—the secondary output voltage V_{SEC} is not fixed by a fixed feed voltage to the circuit. The output voltage (10) is a function of the rate of energy decay in the reverse stroke Q1 (1)—off period of the power device. Thus, the topology gets its name fly-back—an ancient reference to the discharge of an inductive device. This effect can be utilized to provide a voltage output dynamic as the voltage will rise to whatever it needs to fully dissipate the stored core energy. This can provide an inherent means to adjust output voltage without active intervention.

Applications of power supplies to devices such as, but not limited to light emitting diodes (LED), ideally require a constant current supply. To provide this, it is necessary to vary the voltage to the non-linear load of the LED load. So, to maintain a constant current, the voltage will need to vary. The available range of voltage is the compliance range of a constant current source. To achieve this either over small or large dynamics, either the Pulse Width (PW) is altered or input voltage to the output stage is increased. The variable input voltage method requires a pre-converter of some type to adjust the voltage input. Adjusting the PW has a limitation of having a limited dynamic range.

This invention utilizes the voltage dynamic of the fly-back topology to correct for the rippling of the unfiltered rectified line voltage and optimizing efficiency by utilizing the magnetic core bi-directionally—core flux goes from a negative flux value to some other positive value.

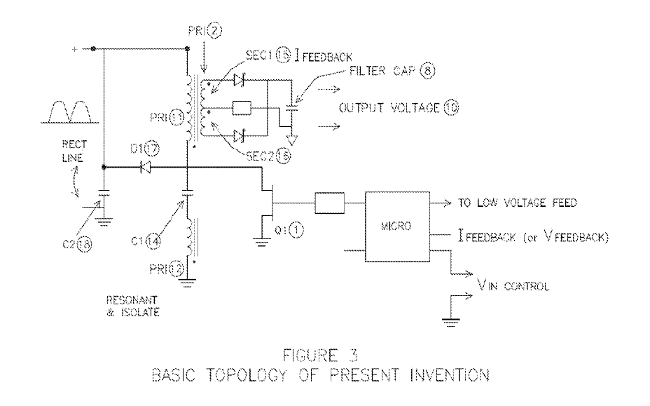

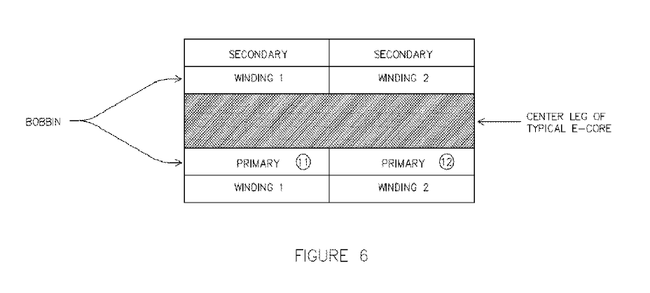

This topology can be seen in FIG. 3. A transformer has two primaries 11,12 that are nearly identical—except for minor leakage flux differences, FIG. 6. There, phasing is as shown in a standard dot convention. As shown, the connection is phase add. Otherwise a cancelation of flux in the core would occur, and no transfer of energy to the secondary would occur. The two primaries 11,12 are in series but isolated by a capacitor C1 (14). This capacitor (14) both isolates and controls the rate of change of current with time (di/dt) and, therefore, the voltage on the secondary, SEC2 (16), split winding half that is phased with this part of the operational cycle. The capacitor (14) can be selected for maximum efficiency or maximum compliance range. For maximum efficiency, the capacitor (14) is select to provide the lowest rise of voltage across the switch during the instant just after being biased off

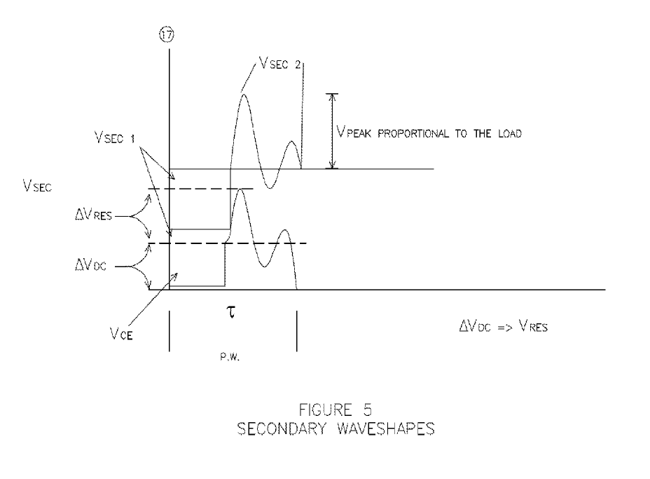

The two primaries 11,12 could be bifilar wound but oppositely phased for optimal operation and potentially negating the need for diode D1 (17) in FIG. 3. This diode stabilizes transient voltage generation caused by parasitics that make the two primaries windings less then identical. This clamps the voltage at the drain of Q1 (1) to the primary resonating capacitor C2 (18), resulting in wave shapes seen in FIG. 5.

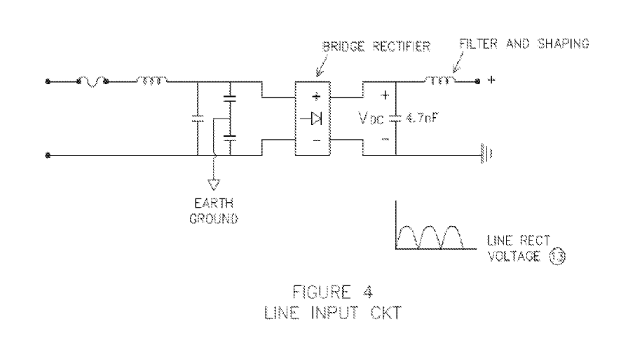

Power factor is mitigated by not filtering the rectified line voltage FIG. 4 (13). During periods when the forward operation provides a voltage greater than what is on the filter capacitors (8), energy flows into the storage capacitor C2 (18). On the opposite part of the cycle, when the switch is off, conduction is initiated in the diode of the split secondary winding SEC2 (16) FIG. 4. Energy flows here as well. When the applied voltage is below that which biases on the forward rectifier branch, the fly-back- branch, SEC2 (16), will cause the voltage to rise to a level to transform and transfer energy to voltage output. This action in itself is adequate to provide energy input to the output voltage (10) to reduce the output ripple to acceptable levels while not distorting the line current severely.

The power factor can be maintained at levels of better than 90% with total harmonic distortions (THD) of less than 20% by this method and avoids the use high voltage electrolytic.

A more active approach would be to adjust the effective PW from zero cross point to peak to equalize the voltage on each secondary SEC1 (15), SEC2 (16). This is a result of the conservation of flux. In a transformer, it is known that as a result of conservation of flux that if for a fixed cycle time the integral of the area under the output voltage curves are equal. To force the voltage up during the lower voltage areas of the rectified line voltage, the PW would be reduced during the low periods and increased during higher applied voltages. With the use of a micro controller (micro) this ratio of pulse width to applied input voltage is constructed to extract optimal amount of energy over any half line cycle with low distortion of the line current.

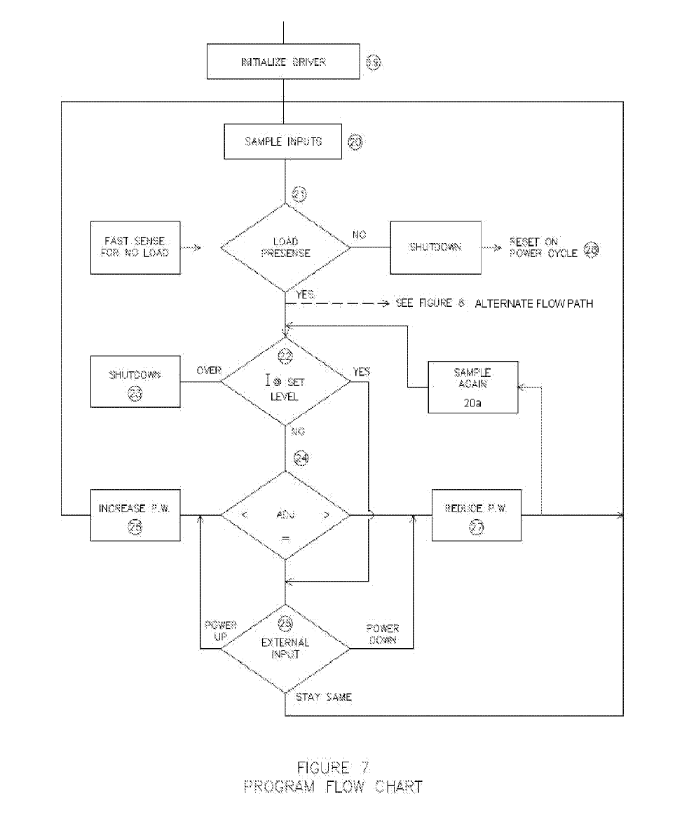

The control flow is seen in FIG. 7. The micro controller is first initialized in step (19) for first operation, next is a rapid sampling (20) of the load current. This is to prevent a condition prevalent in constant current power supply. The increase the output voltage is an attempt to attain selected current level. If a load is not present the device that is connected can be presented with a voltage many times its allowed maximum and destroy it before the control loop can correct for change. This is very important with LEDs that are very sensitive and can be destroyed by this scenario. In step (21), we see the decision block testing for the no load condition. The processor is put in sleep mode (28) until line power is removed and reapplied. This test is very early in the ramp up and prevents appreciable voltage from reaching the output terminals.

The flow can take one of two directions at this point (21). One is to move on to the main control loop (22) check for proper current level and shutdown if over (23), adjust (24), or if at set level, jump to user level select (25) for operation below the internal set point. The adjust decision (24) is if the test is less than set, increase pulse width (26), if the test is greater than set, then reduce pulse width (27), or is test is equal to set go to user level select (25).

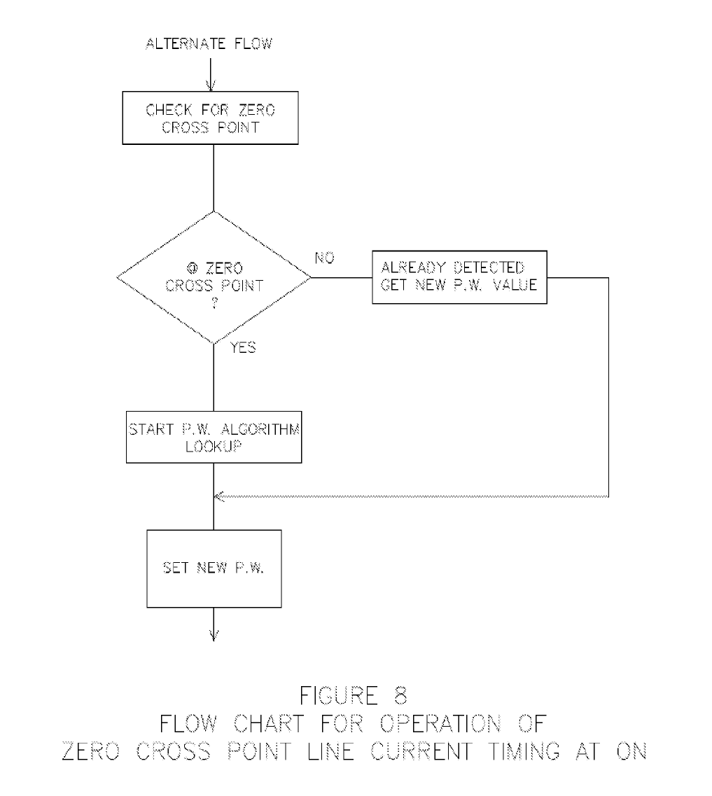

FIG. 8 is the alternate control flow path. In this path, the zero cross-point is detected and mitigates the control, based not only on load demand but also on phase location of the input mains waves-shape. This allows a further improvement of line power factor and distortion to meet the most rigorous line standard by mitigating the instantaneous value along the driving voltage sine wave and can make the line current more like the voltage wave shape. Conversely, distortion can be intentionally introduced to create harmonics that can negate mains distortion to improve mains efficiencies through reduced transformer K factor This is accomplished by either a look up table based on clock speed and zero cross point detection or more dynamically through an algorithm and voltage/current sensing to current for a sine current. Also, new lookup tables can be actively uploaded to provide better mains performance as described earlier.

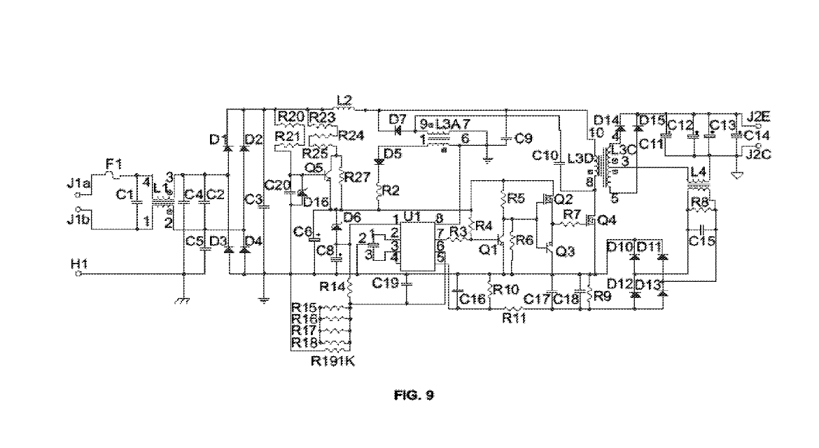

FIG. 9 shows a complete schematic of the current invention. The efficiency and low cost attributes are evident as a functionality of three power devices, power factor correction (PFC) stage and two outputs of a half bridge stage are replaced by one power component. The associated loss overhead is reduced by better than a third. Also, the elimination of high voltage electrolytic capacitors and associated losses remove the life limiting effects providing for expected life values greater than 60,000 hours mean time between failures (MTBF) which is the typical limit of power supplies with them. Also, when the unit runs at reduced levels, the reduced overhead allows the unit to have a high efficiency over a wide power range. Over a 6:1 power range, the efficiency changes no more than 1.4:1. This can be utilized in several ways. One is to allow the unit to be programmable for diverse operating levels. Thus, a single unit to meet many power/current/voltage requirements. The other way is to use it in dimming application where the operating power level can be mitigated to lower values without efficiency compromise.

While this invention is susceptible of embodiments in many different forms, there is shown in the drawings and will herein be described in detail preferred embodiments of the invention with the understanding that the present disclosure is to be considered as an

Exemplification of the principles of the invention and is not intended to limit the broad aspect of the invention to the embodiments illustrated.

1. A power supply with multimodal operation topology comprising a fly-back forward operation having low distortion and a high power factor utilizing a single power component.

2. The power supply of claim 1 further comprising a means for providing expanded compliance voltage.

3. The power supply of claim 2 further comprising a split winding to operate in a multi-modal topology to optimize power throughput by using a magnetic core bi-directionally.

4. The power supply of claim 2 further comprising a split winding to operate in a multi-modal topology to optimize power throughput by using a magnetic core bi-directionally.

5. The power supply of claim 1 further comprising means for detecting a zero cross-point and mitigating a control based on a load demand and a phase location of an input mains waves-shape.

6. The power supply of claim 5 wherein the means for detecting a zero cross-point and mitigating a control based on a load demand and a phase location of an input mains waves shape provides an improvement of a line power factor and distortion by mitigating an instantaneous value along a driving voltage sine wave.

7. The power supply of claim 6 wherein the means for detecting a zero cross-point and mitigating a control based on a load demand and a phase location of an input mains waves shape enhances the input mains waves shape such that the input mains waves shape substantially mimics a voltage wave shape.

8. The power supply of claim 1 further comprising a means for intentionally introducing distortion to create harmonics for negating an input mains distortion to improve mains efficiencies by reducing a transformer K factor.

9. A power supply for a non-linear load comprising:
a fly-back circuit to correct for a rippling of a line voltage; and
a means for optimizing efficiency by utilizing a magnetic core of the fly-back circuit bi-directionally.

10. The power supply of claim 9 wherein the line voltage is unfiltered.

11. The power supply of claim 10 wherein a flux in the magnetic core goes from a negative flux value to a positive flux value.

12. The power supply of claim 11 wherein the fly-back circuit comprises a pair of primary coils electrically connected in series.

13. The power supply of claim 12 further comprising a first primary coil in the pair of primary coils is isolated from a second primary coil in the pair of primary coils by a capacitor.

14. The power supply of claim 13 wherein the fly-back circuit comprises a secondary coil wherein a voltage on the secondary coil is controlled by the capacitor.

15. The power supply of claim 14 wherein the first primary coil and the second primary coil are bifilar wound and oppositely phased.

16. The power supply of claim 15 wherein a power factor of the power supply is maintained at levels of greater than 90% with total harmonic distortions of less than 20%.

17. The power supply of claim 15 further comprising a means for adjusting a pulse width from a zero cross point to a peak to equalize voltage across the secondary coil.

18. The power supply of claim 17 wherein the means for adjusting the pulse width comprises a microcontroller.

19. The power supply of claim 9 further comprising means for detecting a zero cross-point and mitigating a control based on a load demand and a phase location of an input mains waves-shape.

20. The power supply of claim 19 wherein the means for detecting a zero cross-point and mitigating a control based on a load demand and a phase location of an input mains waves shape provides an improvement of a line power factor and distortion by mitigating an instantaneous value along a driving voltage sine wave.

21. The power supply of claim 20 wherein the means for detecting a zero cross-point and mitigating a control based on a load demand and a phase location of an input mains waves shape enhances the input mains waves shape such that the input mains waves shape substantially mimics a voltage wave shape.

22. The power supply of claim 9 further comprising a means for intentionally introducing distortion to create harmonics for negating an input mains distortion to improve mains efficiencies by reducing a transformer K factor.

23. A control apparatus comprising a means for using control algorithms to provide a controlled output for safe efficient control of an output state.

24. The control apparatus of claim 23 further comprising a means for sensing for an output conduction and terminating on a detection of a no load situation.
